(19) United States
(12) Patent Application Publication
(10) Pub. No.: US 2017/0025861 A1
(43) Pub. Date: Jan. 26, 2017

(54) DETECTING THE PRESENCE OR ABSENCE OF A USER

(71) Applicant: General Electric Company, Schenectady, NY (US)

(72) Inventors: Dong Hun Lee, Gunpo-si (KR); Woong Jeon, Bucheon-si (KR)

(21) Appl. No.: 14/806,733

(22) Filed: Jul. 23, 2015

(51) Int. Cl. H02J 4/00; H04B 17/318; H04L 12/28; H04W 4/00

(52) U.S. Cl. CPC H02J 4/00; H04W 4/008; H04B 17/318; H04L 12/2803; G05B 2219/2639

(57) ABSTRACT

Systems and methods for detecting the presence or absence of a user at a facility are provided. A user device can be configured to communicate with one or more appliances located at the facility. In particular, the user device can be configured to broadcast one or more beacon advertisements, which can be detected by the one or more appliances when located within the broadcast range of the user device. Further, the user device can be configured to broadcast one or more multicast domain name system (mDNS) queries over a local area network. The mDNS queries can be received by the one or more appliances. Such signals can be used to determine the presence or absence of the user at the facility. In particular, such signals can be used independently to detect presence, or such signals can be used in conjunction to detect presence.

### FIELD OF THE INVENTION

The present disclosure relates generally to communication between one or more appliances and a user device, and more particularly to detecting the presence or absence of a user at a facility based at least in part on communication between one or more appliances and a user device.

### BACKGROUND OF THE INVENTION

Several appliances can be installed on a single premises such as a residential home, an office building, or a commercial establishment. For instance, a refrigerator, a microwave oven, a cooking appliance having a stove and/or oven, heating and/or cooling systems can be installed. Modern appliances are more sophisticated than their earlier counterparts, and often include microcontrollers and/or microprocessors that allow a user greater interaction with the appliance. For instance, an appliance can be programmed or reprogrammed as well as provide diagnostic information. In addition, such modern appliances may be configured to communicate over a network. For instance, a user may remotely control one or more appliances over a local network, such as a home area network, or even a wide area network, such as the Internet.

Such communication can provide for a safer, more efficient operation of appliances. For instance, a user may be able to control the operation of an appliance from a remote location, while the user is absent from the premises where the appliance is installed. Systems have been developed that are configured to detect when a user is absent from a premises. Conventional techniques may include using infrared sensors to detect presence or absence of users at a premises. However, such techniques may be costly and/or inaccurate.

Thus, a need exists for an improved system for detecting the presence or absence of a user at a premises, and for communicating an operational state of one or more appliances at the premises when the absence of the user is detected.

### BRIEF DESCRIPTION OF THE INVENTION

Aspects and advantages of the invention will be set forth in part in the following description, or may be obvious from the description, or may be learned through practice of the invention.

One example aspect of the present disclosure is directed to a system for detecting the presence of a user at a facility. The system includes one or more appliances located at a facility. The one or more appliances configured to communicate with a user device. The system further includes a home energy management system configured to communicate with at least one of the one or more appliances. The home energy management system is further configured to receive a plurality of signals associated with communication between the user device and the one or more appliances, and to determine whether the user is present or absent at the facility based at least in part on the plurality of received signals.

Another example aspect of the present disclosure is directed to a home energy management system. The home energy management system includes one or more processors, and one or more memory devices. The one or more memory devices store computer-readable instructions that when executed by the one or more processors cause the one or more processors to perform operations. The operations include receiving a first signal associated with the presence or absence of a user at a facility. The first signal is indicative of a received signal strength indication value associated with a user device. The operations further include receiving a second signal associated with the presence or absence of the user. The second signal is indicative of a time period between beacon advertisements detected by one or more appliances. The beacon advertisements are broadcast by the user device. The operations further include receiving a third signal associated with the presence or absence of the user. The third signal is indicative of a time period between domain name system queries received by the one or more appliances. The domain name system queries are broadcast by the user device. The operations further include determining whether the user is present or absent at the facility based at least in part on the received first, second and third signals.

Yet another example aspect of the present disclosure is directed to a computer-implemented method of detecting a presence or absence of a user at a facility. The method includes receiving, by one or more computing devices, a first signal associated with the presence or absence of a user at a facility. The first signal is indicative of a received signal strength indication value associated with a user device. The method further includes receiving, by the one or more computing devices, a second signal associated with the presence or absence of the user. The second signal is indicative of a time period between beacon advertisements detected by one or more appliances. The beacon advertisements are broadcast by the user device. The method further includes receiving, by the one or more computing devices, a third signal associated with the presence or absence of the user. The third signal is indicative of a time period between domain name system queries received by the one or more appliances. The domain name system queries are broadcast by the user device. The method further includes determining, by the one or more computing devices, whether the user is present or absent at the facility based at least in part on the received first, second and third signals.

Variations and modifications can be made to these example embodiments of the present disclosure.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts an example appliance network according to example embodiments of the present disclosure;

FIG. 2 depicts an example system for detecting the presence of a user according to example embodiments of the present disclosure;

FIG. 3 depicts an example system for detecting the presence of a user according to example embodiments of the present disclosure;

FIG. 4 depicts an example system for detecting the presence of a user according to example embodiments of the present disclosure;

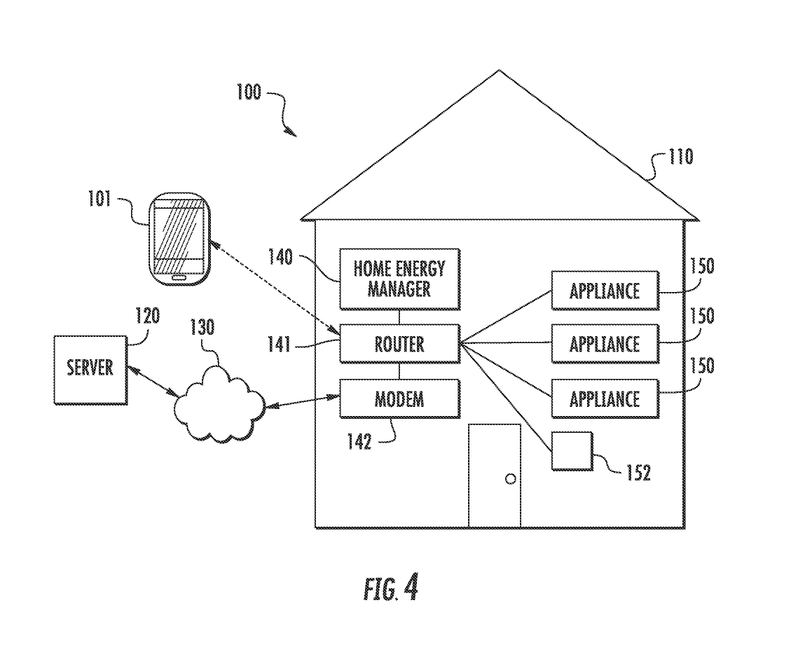

FIG. 5 depicts an example system for providing one or more notifications to a user according to example embodiments of the present disclosure; and

FIG. 6 depicts a flow diagram of an example method of detecting the presence of a user according to example embodiments of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Example aspects of the present disclosure are directed to systems and methods for detecting the presence of a user. In particular, presence of the user can be determined based at least in part on one or more signals associated with a user device. A user device can be a smartphone, tablet, wearable computing device, laptop, or any other suitable computing device capable of being carried by a user while in operation.

According to example embodiments, presence of a user can be determined using multiple techniques. For instance, a first technique for detecting presence can include determining a received signal strength indication (RSSI) of one or more signals broadcast by a user device. For instance, the user device can broadcast one or more signals using a short range wireless communication technology, such as for instance, WiFi or Bluetooth Low Energy (BLE). One or more appliances can be configured to detect the one or more signals broadcast by the user device. In particular, one or more entry appliances can be positioned proximate one or more entries of a facility, such as a residential home, restaurant, office building, warehouse, or other suitable facility. For instance, the one or more entry appliances can comprise a door locking device, a smart light device, or any other suitable device configured to detect the one or more signals broadcast by the user device. The one or more entry appliances can be further configured to determine an RSSI of the one or more detected signals. When the RSSI of a detected signal falls below a threshold, it can be determined that the user has left the facility.

In example embodiments, the one or more entry appliances can include directional antennas for detecting the one or more signals. For instance, the antennas can have radiation patterns that are directed away from the entrance, but not towards the interior of the facility. In this manner, the one or more entry appliances may be configured to detect only signals being broadcast by the user device as the user device is entering or exiting the facility. In example embodiments, an entry appliance may be configured to distinguish a user device entering a facility from a user device exiting the facility based at least in part on one or more received signals and the determined RSSI of such signals.

According to further aspects of the present disclosure, a second technique for determining the presence of a user can include detecting beacon advertisements from a user device. One or more appliances can be in communication with the user device when the user device is located in or near the facility. The one or more appliances can include the one or more entry appliances and/or various other suitable appliances, such as a refrigerator, microwave, washer/dryer, smart thermostat, oven, etc. In example embodiments, the user device can periodically broadcast one or more beacon advertisements to the appliances, for instance, using WiFi or BLE technologies. The broadcasted messages can be received by the appliances when the appliances are in the broadcast range of the user device. In this manner, if beacon advertisements are not received by any of the appliances for a threshold amount of time, it can be determined that the appliances are not located within the broadcast range of the user device, and that user has exited the facility.

In alternative embodiments, the appliances can also periodically broadcast beacon advertisements to the user device. In this manner, the presence or absence of the user can be determined based at least in part on whether the user device detects beacon advertisements from any of the appliances. For instance, if the user device does not detect beacon advertisements from any of the appliances for a threshold period of time, it can be determined that the user has exited the facility.

According to further aspects of the present disclosure, a third technique for detecting presence of a user can include detecting one or more multicast Domain Name System (mDNS) queries from the user device via a local area network (e.g. a WiFi network). The user device and the one or more appliances can be configured to communicate with each other through the local area network. In example embodiments, the user device can periodically provide an mDNS query over the local area network to resolve a destination host name to an IP address. In particular, the user device can send an Internet Protocol (IP) multicast query message asking the host (e.g. the destination appliance) having the host name to identify itself. The mDNS query can include an identification advertisement of the user device. The destination appliance can then multicast a message that includes the IP address of the appliance. In example embodiments, if the one or more appliances do not receive a query message from the user device for a threshold amount of time, the user of the user device can be determined to be absent from the facility.

In example embodiments, multiple presence detecting techniques can be used in conjunction to determine the presence or absence of a user at a facility. For instance, a user can be determined to be present at the facility if at least one of the techniques described above indicate that the user is present. In this manner, if the second and the third technique indicate that the user is absent but the first technique indicates that the user is present, it can be determined that the user is present in the facility. It can further be determined that the user is absent from the facility if the all three techniques indicate that the user is absent. In alternative embodiments, various other suitable combinations of techniques can be used to determine the presence or absence of a user. For instance, in such embodiments, if two out of the three techniques indicate that the user is absent, it can be determined that the user is absent.

When a user is determined to be absent from the facility, one or more notifications can be sent to the user device. For instance, the one or more notifications can be associated with an operational state of at least one of the appliances. For instance, a notification can be indicative of a oven being turned on, a refrigerator door being open, a running washer or dryer, an air conditioner being turned on, etc. The user device may then be configured to control the operation of the appliances responsive to an input from the user.

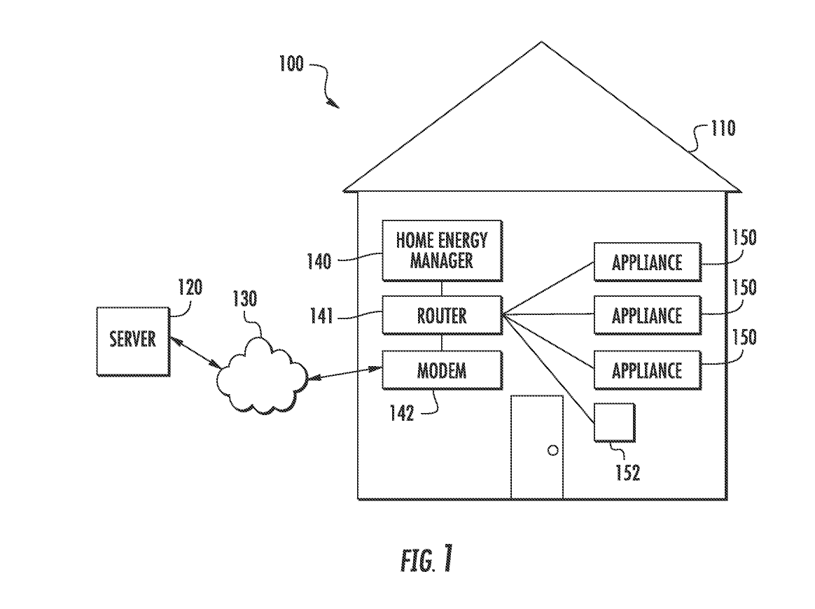

Referring now to the figures, FIG. 1 depicts an example system 100 for detecting the presence of a user. System 100 can include a facility 110, a server 120, a network 130, a home energy manager 140, a router 141, a modem 142, one or more appliances 150, and an entry appliance 152. Due to the inherent flexibility of computer-based systems, one of ordinary skill in the art, in light of the disclosures contained herein, will understand that a great variety of possible configurations, combinations, and divisions of tasks and functionality between and among the components of a system 100 are possible. For instance, aspects of the systems and methods disclosed herein can be implemented using a single computing device or across multiple computing devices.

Server 120 can be configured as a cloud-like device for storage of appliance data and user data. The server 120 can include one or more memory devices and one or more processors. By way of example, any/all of the memory or processing devices can include microprocessors, CPUs or the like, such as general or special purpose microprocessors operable to execute programming instructions or micro-control code associated with operation of an appliance. The memory may represent random access memory such as DRAM, or read only memory such as ROM or FLASH. In one embodiment, the processor executes programming instructions stored in memory. The memory may be a separate component from the processor or may be included onboard within the processor. Alternatively, the controller might also be constructed without using a microprocessor, using a combination of discrete analog and/or digital logic circuitry (such as amplifiers, integrators, comparators, flip-flops, AND gates, and the like) to perform appliance control functionality instead of relying upon software.

The server can store appliance data associated with various appliances. The appliance data can include any information associated with an appliance such as software, firmware, software and/or firmware updates, database information, operation information, user guide information, etc. The server can also store user data optionally provided by a user purchasing the appliance. The user data can include the identity of a local computing device (e.g. home energy manager 140 or local network device) installed at a premises associated with the user as well as other user information, such as the identity of other appliances connected with the user's home area network.

Network 130 can be any type of communication network. For instance, network 130 can include one or more of a wireless network, a wired network, a personal area network, a local area network, a wide area network, the Internet, etc.

Home energy manager 140 can communicate with server 120 via network 130. Home energy manager 140 can be one or more computing devices having a processor(s) and a memory device(s) that oversees communication within a home area network from a single interface. The home energy manager 140 can be connected to appliances 150 and/or a plurality of home devices.

Router 141 can provide a home area network. The home area network can be any type of network that allows at least one appliance to communicate with another device, such as home energy manager 140. The router 141 and/or the home area network can include any combination of wired, wireless, or other network links. While only three appliances 150 are illustrated in FIG. 1 as being coupled to router 141, any number of appliances within a single facility can be coupled to router 141.

Appliances 150 can be any appliance coupled to network 130. For instance, appliances 150 can include refrigerators, washing appliances, clothes drying appliances, ovens, cooktops, ranges, microwaves, HVAC systems, and/or various other suitable appliances. Entry appliance 152 can be any appliance coupled to network 130 positioned proximate an entry of facility 110. For instance, as depicted in FIG. 1, entry appliance 152 can be positioned proximate a front door of facility 110.

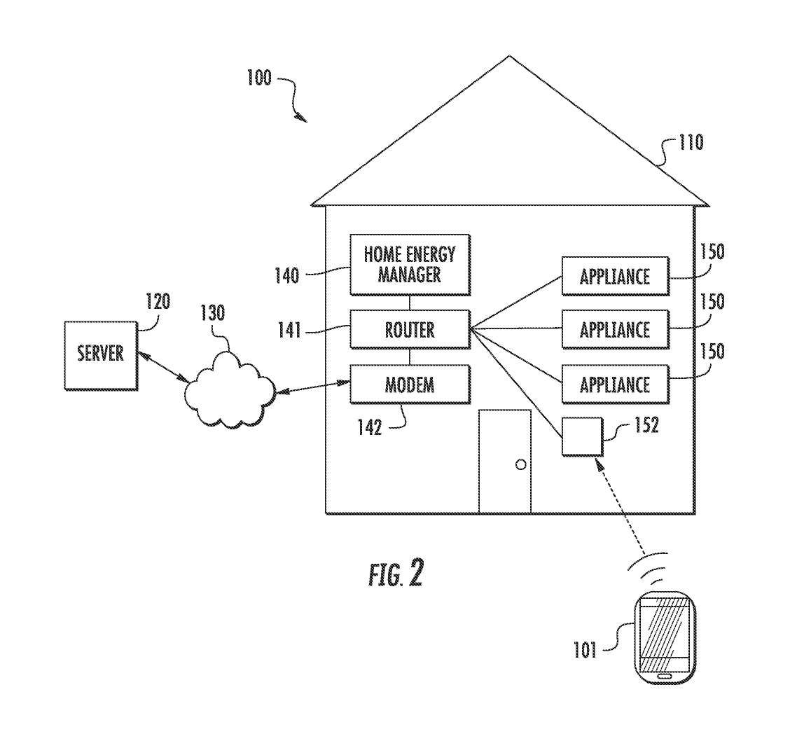

As described above, various techniques can be used to detect the presence of a user in a facility having an appliance system, such as system 100. For instance, a first technique for determining presence can include measuring the signal strength of signals transmitted by a user device. FIG. 2 depicts an example system 100 for determining presence of a user according to example embodiments of the present disclosure. FIG. 2 further depicts a user device 101 that can be configured to communicate with system 100. For instance, as depicted, user device 101 can be configured to transmit one or more signals, for instance, using short range wireless communication technologies (e.g. WiFi, Bluetooth Low Energy, etc.). In example embodiments, such broadcasted signals can be detected by entry appliance 152. In particular, entry appliance 152 can be configured to scan for a signal strength indicator (RSSI) associated with the signals transmitted by user device 102. The RSSI of a signal transmitted by user device 102 and received by entry appliance 152 can correspond to the distance between user device 102 and entry appliance 152. For instance, as a user walks out the front door of facility 110, and travels away from facility 110, the RSSI (as measured by entry appliance 152) of any signals transmitted by user device 102 will decrease. If the measured RSSI of the signal is below a threshold level, it can be determined that the user is absent from the facility.

Entry appliance 152 and/or appliances 150 can have one or more antennas configured to receive signals transmitted, for instance, by user device 102. In example embodiments, the one or more antennas of entry appliance 152 can be directional antennas having directional receiving patterns. Such receiving patterns can be directed away from facility 110, such that the antennas do not receive signals from at least a portion of the interior of facility 110. In this manner, entry appliance 152 may only detect signals transmitted by user device 102 when user device 102 is located within the receiving pattern of the antennas (e.g. outside of facility 150 and/or near the entry).

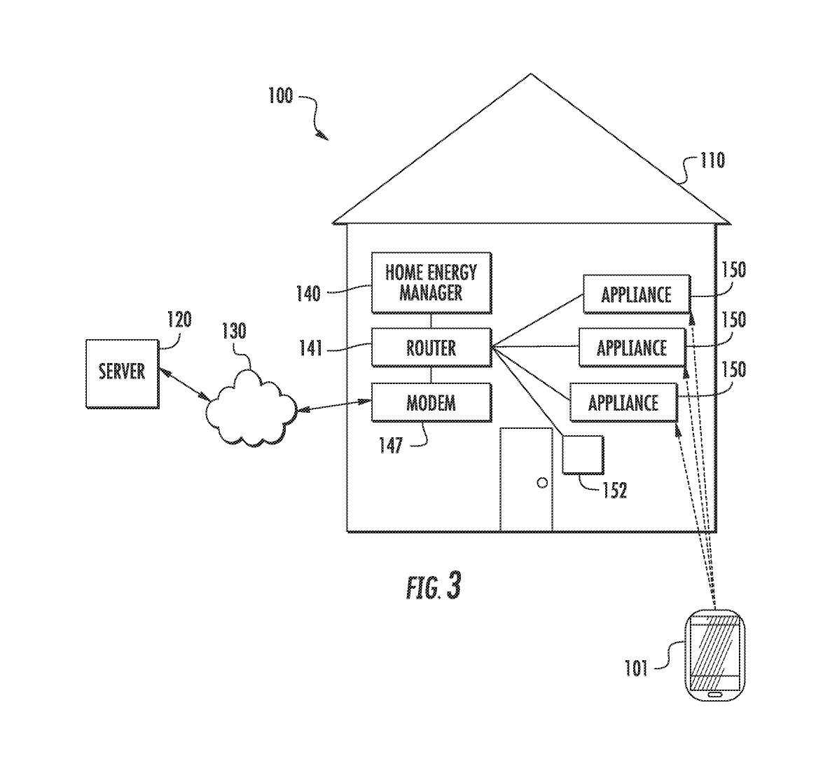

A second technique for determining the presence of a user can include receiving beacon messages from the user device. For instance, FIG. 3 depicts an example system 100 for determining presence of a user according to example embodiments of the present disclosure. As described above, user device 102 can transmit one or more signals that can be received by one or more of appliances 150 and/or entry appliance 152. For instance, user device 102 can periodically broadcast beacon data that can be detected by appliances 150 when the user data is in or near facility 110. The broadcasted beacon data can include a beacon advertisement. The beacon advertisement can include an identifier associated with user device 102. For instance, the beacon advertisement can include a media access control (MAC) address associated with the user device, and/or other suitable identifier (e.g. universally unique ID, a URL, a sequence of bytes, an encrypted identifier, etc.).

Appliances 150 can associate the identifier (e.g. the MAC address) with user device 102. In example embodiments, if appliances 150 do not receive a beacon advertisement from user device 102 (e.g. a beacon advertisement having the identifier associated with user device 102) for a threshold period of time, it can be determined that the user is absent from facility 110. For instance, the threshold period of time can be a period between about 2 minutes and about 30 minutes. As used herein, the term “about,” when used in reference to a numerical value, is intended to refer to within 20% of the numerical value.

In example embodiments, appliances 150 can also periodically broadcast (e.g. using short range wireless communication technology) beacon data (e.g. beacon advertisement) including an identifier associated with the appliance. Similar to the identifier broadcast by user device 102, the identifier broadcast by appliances 150 can include a MAC address associated with the appliance, and/or other suitable identifier (e.g. universally unique ID, a URL, a sequence of bytes, an encrypted identifier, etc.). In such embodiments, presence of the user can be determined based on whether user device 102 receives a beacon advertisement from at least one of appliances 150. For instance, if user device 102 does not receive a beacon advertisement from at least one of appliances 150 for a threshold amount of time, then it can be determined that user device 102 is absent from facility 110.

In further embodiments, a third technique for determining presence of a user can include a multicast Domain Name System (mDNS) query associated with user device 102. In particular, user device 102 and appliances 150 can be connected to a home area network (e.g. network 130), for instance, via router 141. User device 102 can periodically broadcast identifying information over the home area network. For instance, user device 102 can broadcast an mDNS query to appliances 150. The mDNS query can include information such as a MAC address of user device 102. Appliances 150 can associate the MAC address with user device 102. When at least one of appliances 150 receive an mDNS query having the associated MAC address, it can be determined that user device 102 is present in facility 110. When appliances 150 do not receive an mDNS query having the associated MAC address for a threshold period of time, it can be determined that user device 102 is absent from facility 110.

In alternative embodiments, appliances 150 can also broadcast mDNS information (e.g. MAC addresses, manufacturer information, device types, etc.) via router 141. User device 102 can receive the mDNS information and associate the received MAC addresses with the respective appliances. When user device 102 receives mDNS information having at least one of the associated MAC addresses, it can be determined that user device 102 is present in facility 110. If user device 102 does not receive mDNS information having at least one of the associated MAC addresses for a threshold period of time, it can be determined that user device 102 is absent from facility 110.

In example embodiments, presence of a user can be determined using the first, second, and third techniques in conjunction. For instance, a user can be determined to be absent from facility 110 if each of the three techniques indicate that user device 102 is absent. In this manner, the user can be determined to be present in facility 102 if at least one of the three techniques indicates that user device 102 is present. As another example, the user can be determined to be absent from facility 102 if a subset of the first, second, and third techniques indicate that user device 102 is absent. For instance, if the first and second techniques indicate that user device 102 is absent, it can be determined that the user is absent. It will be appreciated that those skilled in the art that various other combinations can be used to determine if the user is absent from facility 102.

It will be appreciated that various suitable home appliance configurations can be used to implement aspects of the present disclosure. For instance, one or more appliances, such as appliances 150, can be configured to detect the presence or absence of a user at a facility through communication with a home energy management system, such as home energy manager 140. In alternative embodiments, the presence or absence of a user can be detected at a facility by one or more appliances, such that no communication with a home energy management system occurs. In particular, one or more appliances may be configured to detect the presence or absence of a user at a facility using at least one of the presence detecting techniques described herein.

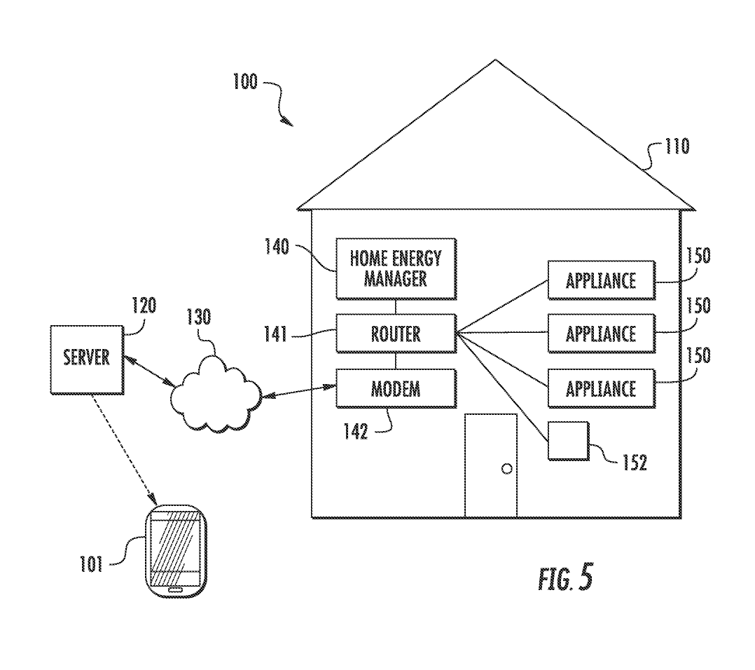

Once it is determined that the user is absent from facility 110, one or more notifications can be sent to user device 102. For instance, FIG. 5 depicts an example system for providing notifications to a user device. In example embodiments, the one or more notifications can be generated by home energy manager 140 and provided to user device 102 via server 120. In alternative embodiments, the one or more notifications can be generated by server 120.

The notifications can be indicative of an operational state of appliances 150. In particular, the notifications can provide information to a user associated with running appliances, energy usage, scheduled operations, etc. For instance, the notifications can inform the user that an oven is turned on, that a refrigerator door is open, that a washer appliance and/or a dryer appliance is running, that an air conditioner unit is turned on, etc. The notifications can further provide a prompt to the user to adjust the operational states of appliances 150. For instance, a notification can provide a prompt to the user to turn the oven off, to close the refrigerator door, to turn the washer and/or dryer off, etc. If the user requests to adjust the operational state of one or more appliances, user device 102 can provide one or more control signals to appliances 150 and/or home energy manager 140 indicative of the user's request (e.g. through communication with server 120). The operational state of the appliances may then be adjusted based at least in part on the user request.

As indicated above, in example embodiments, the presence or absence of a user at a facility may be determined based at least in part on whether a user device, such as user device 102, detects one or more signals broadcast by one or more appliances. In this manner, the presence or absence of a user can be determined by user device 102. User device 102 may then communicate with a remote computing device (e.g. server 120) to determine the one or more notifications associated with appliances 150.

In example embodiments, multiple users can be present in facility 110 at a given time. Each user can have a user device configured to communicate with appliances 150 and/or entry appliance 152. In such embodiments, the presence or absence of each user can be determined according to example embodiments of the present disclosure. When it is determined that each user is absent from facility 110, the one or more notifications can be provided to at least one of the users. In alternative embodiments the one or more notifications can be provided to at least one absent user even if at least one user is still present in facility 110. In such embodiments, the notifications may indicate to the at least one absent user that the at least one present user is present in facility 110.

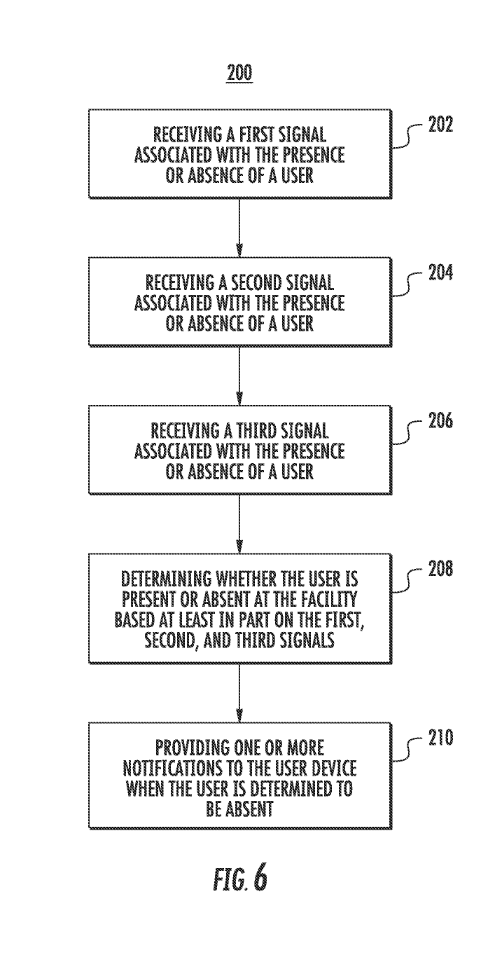

FIG. 6 depicts a flow diagram of an example method 200 of detecting the presence or absence of a user according to example embodiments of the present disclosure. At (202), method 200 can include receiving a first signal associated with the presence or absence of a user at a facility. The first signal can be indicative of an RSSI value associated with a signal broadcast by a user device. As indicated above, the RSSI value can be measured by an entry appliance located proximate an entrance of the facility. The RSSI value can correspond to a distance between the user device and the entry appliance. In example embodiments, when the RSSI value falls below a threshold value, it can be determined that the user device is absent from the facility.

At (204), method 200 can include receiving a second signal associated with the presence or absence of a user at the facility. The second signal can be indicative of a time period between beacon advertisements detected by one or more appliances. As indicated above, a user device can periodically broadcast (e.g. using short range wireless communication technologies) one or more beacon advertisements containing an identifying signal associated with the user device. One or more appliances located at the facility can detect such beacon advertisements when within the broadcast range of the user device. The one or more appliances can then associate the identifying signal with the user device. When the one or more appliances do not detect a beacon advertisement containing the identifying signal for a threshold period of time, it can be determined that the user device is absent from the facility.

At (206), method 200 can include receiving a third signal associated with the presence or absence of the user at the facility. The third signal can be indicative of a time period between DNS (e.g. mDNS) queries received by the one or more appliances. In particular, the user device, when connected to a network (e.g. a home area network or other network) can periodically provide mDNS queries over the network, for instance, via a router. The mDNS query can contain an identifying signal associated with the user device (e.g. MAC address). One or more appliances connected to the network can receive the mDNS query from the user device. The one or more appliances can then associate the identifying signal with the user device. If the time period between mDNS queries received by the one or more appliances from the user device reaches a threshold time period, it can be determined that the user device is absent from the facility.

At (208), method 200 can include determining whether the user is present or absent at the facility based at least in part on the first, second, and third, signals. For instance, if each of the first, second and third signals indicate that the user device is absent, it can be determined that the user is absent from the facility. As another example, if the first and second signals indicate that the user device is absent from the facility, but the third signal indicates that the user device is present, it can be determined that the user is present.

At (210), method 200 can include, when it is determined that the user is absent from the facility, providing one or more notifications to the user device. As indicated above, the one or more notifications can be associated with an operational state of at least one of the one or more appliances. In example embodiments, the one or more notifications may include a prompt to the user to adjust an operational state of the at least one appliance. If the user interacts with the prompt, the user device may provide one or more command signals to the at least one appliance indicative of the interaction.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for detecting the presence of a user at a facility, the system comprising:
one or more appliances located at a facility, the one or more appliances configured to communicate with a user device; and
a home energy management system configured to communicate with at least one of the one or more appliances, the home energy management system further configured to receive a plurality of signals associated with communication between the user device and the one or more appliances, and to determine whether the user is present or absent at the facility based at least in part on the plurality of received signals.

2. The system of claim 1, wherein at least one signal of the plurality of signals is associated with one or more received signal strength indicator values associated with the user device, at least one signal of the plurality of signals is associated with one or more beacon advertisements associated with the user device, and at least one signal of the plurality of signals is associated with one or more multicast domain name system queries associated with the user device.

3. The system of claim 1, wherein the home energy management system is configured to determine whether the user is present or absent at the facility based at least in part by comparing a received signal strength indication value of at least one of the plurality of signals against a signal strength threshold value.

4. The system of claim 3, wherein the received signal strength indication value is determined by an entry appliance located proximate an entrance of the facility.

5. The system of claim 2, wherein the home energy management system is configured to determine whether the user is present or absent at the facility at least in part by determining a time period between beacon advertisements received by the one or more appliances, and comparing the time period to a first threshold time period, the beacon advertisements being broadcast using short range wireless communication technology by the user device.

6. The system of claim 2, wherein the home energy management system is configured to determine whether the user is present or absent at the facility at least in part by determining a time period between beacon advertisements received by the user device, and comparing the time period to a first threshold time period, each beacon advertisement being broadcast by the one or more appliances.

7. The system of claim 5, wherein the first threshold time period is between about 2 minutes and about 20 minutes.

8. The system of claim 5, wherein the home energy management system is configured to determine whether the user is present or absent at the facility at least in part by determining a time period between multicast domain name system queries received by the one or more appliances, and comparing the time period to a second threshold time period, the multicast domain name system queries being broadcast by the user device.

9. The system of claim 6, wherein the home energy management system is configured to determine whether the user is present or absent at the facility at least in part by determining a time period between multicast domain name system queries received by the user device, and comparing the time period to a second threshold time period, each multicast domain name system query being broadcast by the one or more appliances.

10. The system of claim 1, wherein the home energy management system is further configured to, when the user is determined to be absent from the facility, generate one or more notifications associated with the one or more appliances, and provide the one or more notifications to the user device.

11. The system of claim 10, wherein the one or more notifications are indicative of an operational state of at least one of the one or more appliances.

12. The system of claim 11, wherein the one or more notifications provide a prompt for a user to alter the operational state of the at least one appliance.

13. A home energy management system comprising:
one or more processors; and
one or more memory devices, the one or more memory devices storing computer-readable instructions that when executed by the one or more processors cause the one or more processors to perform operations, the operations comprising:
receiving a first signal associated with a presence or absence of a user at a facility, the first signal indicative of a received signal strength indication value associated with a user device;
receiving a second signal associated with the presence or absence of the user, the second signal indicative of a time period between beacon advertisements detected by one or more appliances, the beacon advertisements being broadcast by the user device;
receiving a third signal associated with the presence or absence of the user, the third signal indicative of a time period between domain name system queries received by the one or more appliances, the domain name system queries being broadcast by the user device; and
determining whether the user is present or absent at the facility based at least in part on the received first, second, and third signals.

14. The home energy management system of claim 13, wherein the user is determined to be absent from the facility when each of the first, second, and third signals indicate that the user is absent from the facility.

15. The home energy management system of claim 13, the one or more operations further comprising, when it is determined that the user is absent from the facility, providing one or more notifications to the user device, the one or more notifications indicative of an operational state of at least one appliance associated with the home energy management system.

16. The home energy management system of claim 13, wherein the received signal strength indicator value is associated with one or more signals broadcast by the user device and detected by an entry appliance located proximate an entrance of the facility.

17. The home energy management system of claim 16, wherein the entry appliance has a directional antenna having a directional receiving pattern pointed outward from the entrance of the facility.

18. A computer-implemented method of detecting a presence or absence of a user at a facility, the method comprising:
receiving, by one or more computing devices, a first signal associated with a presence or absence of a user at a facility, the first signal indicative of a received signal strength indication value associated with a user device;
receiving, by the one or more computing devices, a second signal associated with the presence or absence of the user, the second signal indicative of a time period between beacon advertisements detected by one or more appliances, the beacon advertisements being broadcast by the user device;
receiving, by the one or more computing devices, a third signal associated with the presence or absence of the user, the third signal indicative of a time period between domain name system queries received by one or more appliances, the domain name system queries being broadcast by the user device; and
determining, by the one or more computing devices, whether the user is present or absent at the facility based at least in part on the received first, second, and third signals.

19. The computer-implemented method of claim 18, wherein the received signal strength indication value is determined by an entry appliance located proximate an entrance of the facility.

20. The computer-implemented method of claim 18, further comprising, when it is determined that the user is absent from the facility, providing, by the one or more computing devices, one or more notifications to the user device, the one or more notifications associated with an operational state of at least one of the one or more appliances.
